(19) United States
(12) Patent Application Publication
(10) Pub. No.: US 2025/0371291 A1
(43) Pub. Date: Dec. 4, 2025

(54) INFORMATION PROCESSING SYSTEM, INFORMATION PROCESSING METHOD, AND NON-TRANSITORY COMPUTER-READABLE MEDIUM STORING PROGRAM

(71) Applicant: RAKUTEN GROUP, INC., Tokyo (JP)

(72) Inventor: Luis ORELLANA, Tokyo (JP)

(73) Assignee: RAKUTEN GROUP, INC., Tokyo (JP)

(21) Appl. No.: 19/008,896

(22) Filed: Jan. 3, 2025

(30) Foreign Application Priority Data
May 28, 2024 (JP) 2024-086332

(51) Int. Cl. G06F 40/58; G06F 40/242

(52) U.S. Cl. CPC G06F 40/58; G06F 40/242

(57) ABSTRACT

One or more processors extract, from a bilingual dictionary that includes pre-translation terms described in a first language and post-translation terms described in a second language respectively corresponding to the pre-translation terms, one or more pre-translation terms relevant to one or more source texts and one or more post-translation terms respectively corresponding to the one or more pre-translation terms. The processors input, into a language model, a translation prompt that includes the one or more source texts, the one or more pre-translation terms, the one or more post-translation terms, and a translation instruction that includes an instruction for the language model to translate the one or more pre-translation terms to the one or more post-translation terms. The processors acquire, from the language model, a translated text in which the one or more source texts are translated into the second language according to the translation instruction.

### CROSS-REFERENCE TO RELATED APPLICATIONS

This application is based upon and claims the benefit of priority from Japanese Patent Application No. 2024-086332, filed on May 28, 2024, the entire contents of which are incorporated herein by reference.

### BACKGROUND

### 1. Field

The present disclosure relates to an information processing system, an information processing method, and a non-transitory computer-readable medium storing a program.

### 2. Description of Related Art

In recent years, machine translation systems utilizing language models (LM) have been developed. Language models are specialized for natural language processing (NLP) and are a type of generative artificial intelligence (AI). A typical language model generates and outputs a text referred to as a “completion” in response to an input of an instruction text referred to as a “prompt.”

Such language models do not consider the overall meaning of a source text when translating, and thus may assign multiple different translated terms to the same word in the source text. For example, Japanese Laid-Open Patent Publication No. 2009-026100 discloses a technique that uses a bilingual dictionary, which maps pre-translation terms to post-translation terms, to unify the translated terms.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some pre-translation terms included in the bilingual dictionary that are absent from the source text to be translated. Pre-translation terms that are not included in the source text are absent from the machine translation of that text. Thus, if the prompt includes all entries from the bilingual dictionary, excessive data will be input into the language model. As a result, the language model may perform unnecessary computational processing during translation.

The present disclosure relates to an information processing system, an information processing method, and a non-transitory computer-readable medium storing a program, which are capable of correctly inputting a bilingual dictionary into a language model for performing machine translation using the language model.

An information processing system according to an aspect of the present disclosure is configured to translate one or more source texts written in a first language into a second language using a language model. The information processing system includes one or more memories that store computer program code and one or more processors. The one or more processors are configured to read the program code and operate as instructed by the program code. The program code includes extraction code configured to extract, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms. The program code also includes translation prompt input code configured to input a translation prompt into the language model. The translation prompt includes the one or more source texts, the one or more pre-translation terms, the one or more post-translation terms, and a translation instruction. The translation instruction includes an instruction for the language model to translate the one or more pre-translation terms to the one or more post-translation terms. The program code further includes translated text acquisition code configured to acquire, from the language model, a translated text in which the one or more source texts are translated into the second language according to the translation instruction.

An information processing method according to an aspect of the present disclosure is configured to translate one or more source texts written in a first language into a second language using a language model. The information processing method includes causing one or more processors to execute extracting, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms. The information processing method also includes causing one or more processors to execute inputting a translation prompt into the language model. The translation prompt includes the one or more source texts, the one or more pre-translation terms, the one or more post-translation terms, and a translation instruction. The translation instruction includes an instruction for the language model to translate the one or more pre-translation terms to the one or more post-translation terms. The information processing method further includes causing one or more processors to execute acquiring, from the language model, a translated text in which the one or more source texts are translated into the second language according to the translation instruction.

A non-transitory computer-readable medium according to an aspect of the present disclosure stores program code for translating one or more source texts written in a first language into a second language using a language model. The program code includes extraction code configured to extract, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms. The program code also includes translation prompt input code configured to input a translation prompt into the language model. The translation prompt includes the one or more source texts, the one or more pre-translation terms, the one or more post-translation terms, and a translation instruction. The translation instruction includes an instruction for the language model to translate the one or more pre-translation terms to the one or more post-translation terms. The program code further includes translated text acquisition code configured to acquire, from the language model, a translated text in which the one or more source texts are translated into the second language according to the translation instruction.

Other features and aspects will be apparent from the following detailed description, the drawings, and the claims.

### BRIEF DESCRIPTION OF THE DRAWINGS

FIG. 1 is a schematic diagram of an information processing system according to an embodiment.

FIG. 2 is a diagram illustrating a configuration of the bilingual dictionary included in the information processing system shown in FIG. 1.

FIG. 3 is a diagram illustrating a configuration of the terminal device and the information processing device included in the information processing system shown in FIG. 1.

FIG. 4 is a diagram illustrating the information processing method performed by the information processing system shown in FIG. 1.

FIG. 5 is a diagram illustrating an information processing method performed by the information processing system shown in FIG. 1.

FIG. 6 is a diagram illustrating the method for outputting a translated text by the information processing system shown in FIG. 1.

FIG. 7 is a diagram illustrating another configuration of the terminal device and the information processing device included in the information processing system shown in FIG. 1.

FIG. 8 is a diagram illustrating another information processing method performed by the information processing system shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, devices, and/or systems described. Modifications and equivalents of the methods, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

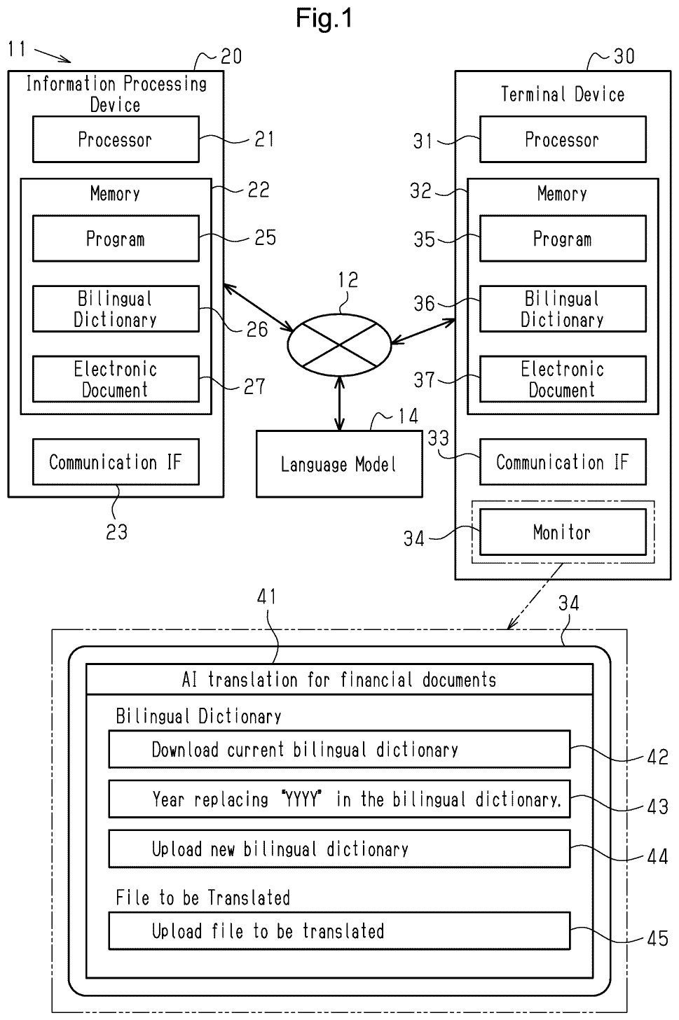

An information processing system 11, an information processing method, and a non-transitory computer-readable medium storing a program according to the present disclosure will now be described with reference to FIGS. 1 to 6. The present disclosure is not limited to these examples and is intended to include all modifications described by the scope of claims and corresponding to equivalents of the scope of claims.

### Overall Configuration of Information Processing System

As shown in FIG. 1, the information processing system 11 is configured to translate one or more source texts written in a first language into a second language using a language model. In the present disclosure, the first language is Japanese and the second language is English. The combination of the first and second languages is not limited to Japanese and English and may include any other combination of languages. The first and second languages may have differences based on the region in which they are used, such as between English (US) and English (UK).

The information processing system 11 includes one or more information processing devices 20. The information processing device 20 may be implemented as a computer that includes, for example, one or more processors 21, one or more memories 22, and a communication interface (IF) 23. The information processing devices 20 may have configurations that are partially or entirely the same, or may be different from one another.

The one or more memories 22 store a program 25 and data used for various types of features. The program 25 includes applications and an operating system. The one or more processors 21 perform the features by executing processes based on the program 25. The communication interface (IF) 23 enables communication with other devices via the network 12. The network 12 includes, for example, the Internet, a wide area network (WAN), a local area network (LAN), a provider terminal, a wireless communication network, a wireless base station, and a dedicated line.

The one or more information processing devices 20 may be capable of communicating with one or more terminal devices 30 via the network 12. The one or more terminal devices 30 may be implemented as a computer that includes one or more processors 31, one or more memories 32, and a communication interface (IF) 33. The one or more processors 31 perform various features by executing processes based on a program 35. The communication interface 33 enables communication with other devices via the network 12. The one or more terminal devices 30 may include a monitor 34. In the information processing system 11, the monitor 34 is configured to display information generated by the information processing system 11.

Each of the one or more processors 21 and 31 is, for example, a central processing unit (CPU), a graphics processing unit (GPU), a microprocessor unit (MPU), a field-programmable gate array (FPGA), or any other arithmetic unit. Each of the processors 21 and 31 is processing circuitry configured to execute various types of software processing. The processing circuitry may include a dedicated hardware circuit (e.g., ASIC) used to process at least some of the software processes. That is, the software processing simply needs to be executed by processing circuitry that includes at least one of a set of one or more software processing circuits and a set of one or more dedicated hardware circuits.

The memories 22 and 32 may be non-transitory computer-readable media. The memories 22 and 32 may each include, for example, a random-access memory (RAM) or another type of a volatile memory. The memories 22 and 32 may be configured to temporarily store the programs 25 and 35 and data, respectively. The memories 22 and 32 may include a storage that permanently stores data including the programs 25 and 35, respectively. The storage may be, for example, a read-only memory (ROM), a hard disk device, a flash memory, or any other non-volatile storage device. The storage may be a removable storage device, such as a memory card. Each of the communication interfaces 23 and 33 may be, for example, implemented as a LAN or another type of wired communication IF.

The information processing system 11 may include a language model 14. Alternatively, the information processing device 20 may use a language model 14 that is not included in the information processing system 11 via the network 12. The language model 14 may be a large-scale language model for natural language processing trained using a large amount of text data. The language model 14 may be a general-purpose language model that can be adapted to perform various natural language processing tasks, such as translation, information extraction, text summarization, text generation, and question-and-response interactions. The language model 14 may be implemented on the information processing device 20 or the terminal device 30.

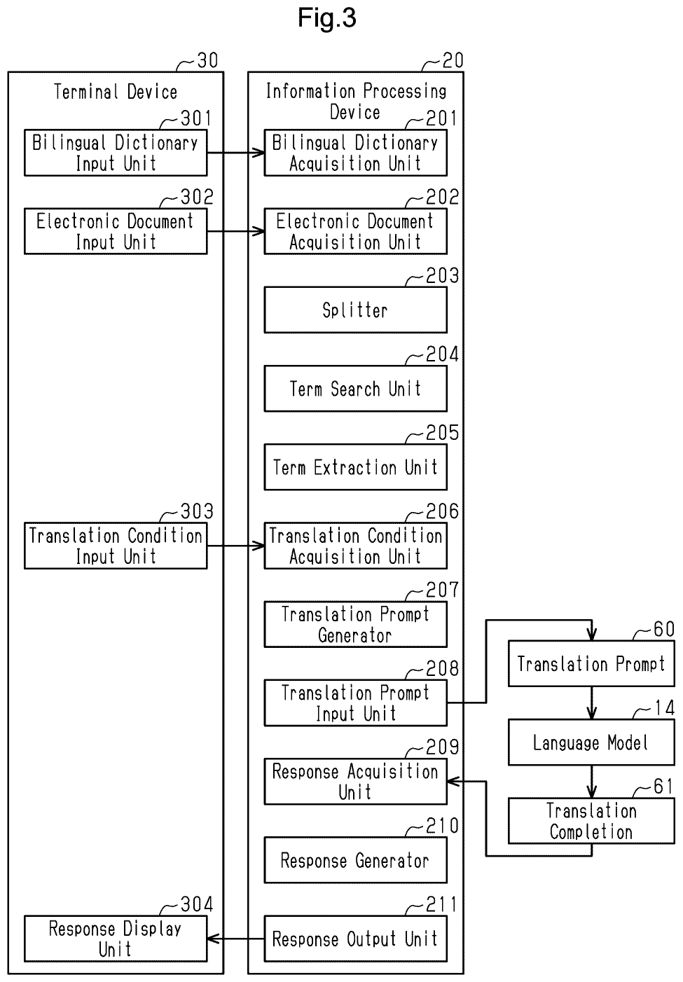

The language model 14 is configured to generate a text in response to a prompt 60 (refer to FIG. 3) that includes an instruction to output the text as a completion 61 (refer to FIG. 3). In the present disclosure, the information processing device 20 generates a prompt 60 and inputs it to the language model 14. Subsequently, the information processing device 20 edits the completion 61 generated by the language model 14, if necessary, and then outputs it.

In the present disclosure, the prompt 60 may include a translation prompt 60. The translation prompt 60 includes an instruction text for translating one or more source texts written in the first language into the second language. In the present disclosure, the completion 61 is a translation completion 61. The translation completion 61 may include a translated text, which is the result of translating one or more source texts written in the first language into the second language.

### Electronic Document

The memory 22 of the information processing device 20 stores one or more electronic documents 27. The one or more electronic documents 27 may be electronic documents 37 that are uploaded from the memory 32 of the terminal device 30 to the information processing device 20 and then stored in the memory 22.

The one or more electronic documents 27 and 37 are files such as HTML, PDF, and plain text files containing contents created for internal or external viewing. However, the file formats of the electronic documents 37 are not limited to these examples. The electronic documents 27 and 37 may include at least one of a table, a diagram, or text data.

In the present disclosure, the electronic documents 27 and 37 may each include one or more source texts written in the first language. The one or more source texts may include, for example, at least one of one or more texts relevant to finance or one or more financial terms. That is, the one or more electronic documents 27 and 37 may be financial documents. The source texts may include a date and a fiscal year. The source texts may include financial terms. The source texts may include numbers written with units.

The units may represent quantities and may differ from the International System of Units, including units specific to particular regions. Such regions may, for example, correspond to the regions where the first language or the second language is used. The units may also include, for instance, currency units described alongside monetary amounts. The currency units may vary depending on the region where each language is used. The monetary amounts can be converted using exchange rates.

### Bilingual Dictionary

The memory 22 of the information processing device 20 stores one or more bilingual dictionaries 26. The one or more bilingual dictionaries 26 may be bilingual dictionaries 36 that are uploaded from the memory 32 of the terminal device 30 to the information processing device 20 and then stored in the memory 22.

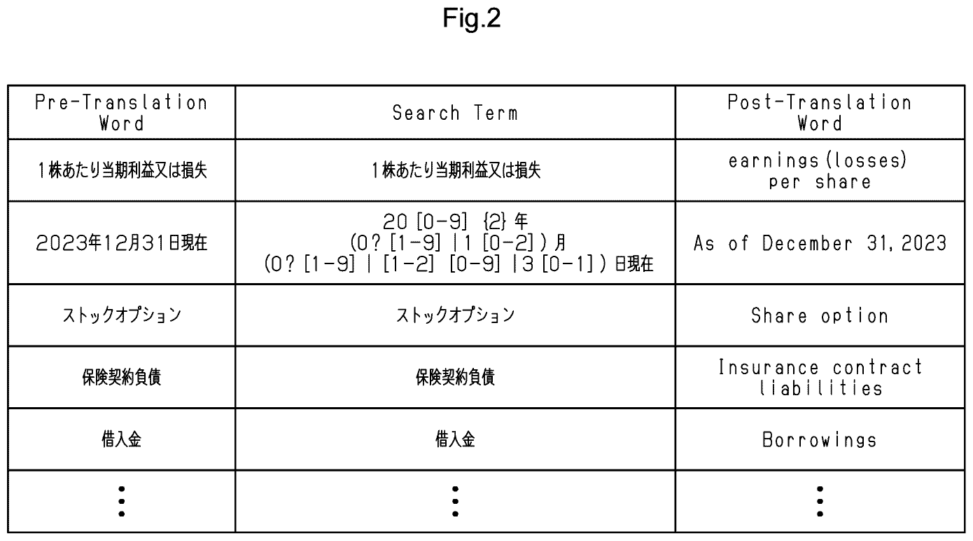

As shown in FIG. 2, each of the bilingual dictionaries 26 and 36 includes pre-translation terms written in the first language, and post-translation terms that respectively correspond to the pre-translation terms and are written in the second language. Each of the bilingual dictionaries 26 and 36 includes search terms respectively corresponding to the pre-translation terms.

In the present disclosure, a set of a pre-translation term, a search term, and a post-translation term that correspond to each other is referred to as a term set, while a pair of a pre-translation term and a corresponding post-translation term is referred to as a translation pair. That is, each of the bilingual dictionaries 26 and 36 includes multiple term sets and multiple translation pairs.

In the present disclosure, multiple pre-translation terms may include one or more financial terms written in the first language. In the present disclosure, multiple post-translation terms may include one or more financial terms written in the second language. Each financial term may be a single word or may be structured as a phrase containing words. Multiple search terms may be the same as the corresponding pre-translation terms. Multiple search terms may include regular expressions of the corresponding pre-translation terms.

For example, when the first language is Japanese and the second language is English (US), a term set includes the pre-translation term “hitokabu atari tohki rieki matawa sonshitsu,” which means earnings (losses) per share, the search term “hitokabu atari tohki rieki matawa sonshitsu,” and the post-translation term “earnings (losses) per share.” In this example, the pre-translation term is the same as the search term. Another term set includes the pre-translation term “2023 nen 12 gatsu 31 nichi genzai” (any year, month, and day; e.g., a year-end closing date), which means “As of Dec. 31, 2023,” the search term “20[0-9]{2} nen (0?[1-9]|1[0-2]) gatsu (0?[1-9]|[1-2][0-9]|3[0-1]) nichi genzai,” and the post-translation term “As of Dec. 31, 2023.” The regular expression included in this term set as a search term is merely an example of regular expressions intended to match any year, month, and day. The regular expression included in the term set as a search term is described depending on the pre-translation term to be matched. In this example, the pre-translation term is different from the search term. The search term may include one or more regular expressions. The search term may include a regular expression indicating a fiscal year or indicating year, month, and day.

### Information Processing Device

As shown in FIG. 3, when the processor 21 runs the program 25 to execute processes, the information processing device 20 operates as a device that includes functional units 201 to 211. The functional units 201 to 211 may be program code.

The functional unit 201 is a bilingual dictionary acquisition unit 201. The bilingual dictionary acquisition unit 201 is configured to acquire one or more bilingual dictionaries 36 from the memory 32 of the terminal device 30. The one or more bilingual dictionaries 36 include one or more pre-translation terms, search terms mapped to the pre-translation terms, and post-translation terms mapped to the pre-translation terms. The bilingual dictionary acquisition unit 201 is configured to store the one or more bilingual dictionaries 36, which have been acquired from the terminal device 30, in the memory 22 as the bilingual dictionaries 26.

The functional unit 202 is an electronic document acquisition unit 202. The electronic document acquisition unit 202 is configured to acquire one or more electronic documents 37 from the memory 32 of the terminal device 30. The one or more electronic documents 37 include one or more source texts. The one or more electronic documents 37 are, for example, financial documents. The electronic document acquisition unit 202 is configured to store the one or more electronic documents 37, which have been acquired from the terminal device 30, in the memory 22 as the electronic documents 27.

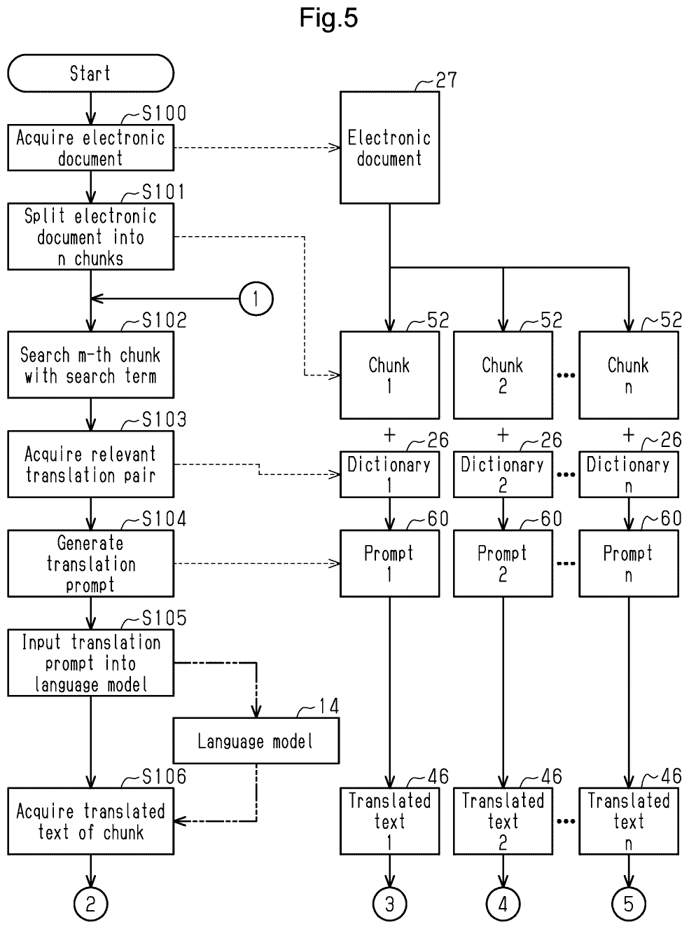

The functional unit 203 is a splitter 203. The splitter 203 is configured to split sentences included in the electronic documents 27 and 37 into chunks 52 (refer to FIG. 5). Each chunk 52 includes one or more source texts written in the first language.

The functional unit 204 is a term search unit 204. The term search unit 204 is configured to search one or more source texts using the search terms included in the bilingual dictionary 26. The term search unit 204 searches each chunk 52 using the search terms included in the bilingual dictionary 26.

The functional unit 205 is a term extraction unit 205. The term extraction unit 205 is configured to extract one or more pre-translation terms relevant to one or more source texts, and one or more post-translation terms respectively corresponding to the pre-translation terms, from the bilingual dictionary 26. The term extraction unit 205 is configured to, for example, extract one or more pre-translation terms corresponding to one or more search terms that have been matched in the search executed by the term search unit 204, and the post-translation terms mapped to these pre-translation terms.

A pair of a pre-translation term included in a source text to be translated and a post-translation term corresponding to that pre-translation term is referred to as a relevant translation pair. That is, the term search unit 204 is configured to extract, from multiple translation pairs in the bilingual dictionary 26, one or more relevant translation pairs relevant to the source text that is to be translated.

The functional unit 206 is a translation condition acquisition unit 206. The translation condition acquisition unit 206 is configured to acquire a translation condition. The translation condition acquisition unit 206 is configured to acquire, for example, the current fiscal year or a designated fiscal year that has been input by the user. For example, the translation condition may be a designated fiscal year that has been designated according to user input via the terminal device 30. The translation condition may be the current fiscal year. The translation condition acquisition unit 206 may be configured to, for example, acquire the current exchange rate. The translation condition may be the current exchange rate.

The functional unit 207 is a translation prompt generator 207. The translation prompt generator 207 is configured to generate a translation prompt 60 that is to be input into the language model 14. The translation prompt 60 may be generated in correspondence with each chunk 52. The translation prompt 60 may include one or more source texts to be translated. The translation prompt 60 may include the relevant translation pairs extracted by the term extraction unit 205. One or more pre-translation terms included in the relevant translation pairs may be extracted based on the result of searching one chunk 52 using one or more search terms.

The translation prompt 60 may include a translation instruction. The translation instruction may include an instruction for the language model 14 to translate one or more pre-translation terms into one or more corresponding post-translation terms. The translation instruction may include an instruction for the language model 14 to generate a translated text by replacing the number of a fiscal year included in one or more source texts with the current fiscal year or the designated fiscal year.

The translation instruction may include an instruction for the language model 14 to translate one or more terms, other than one or more pre-translation terms included in one or more source texts, using financial terms. This instruction may be an instruction text to prompt the language model 14 to respond as a financial expert, such as, “You are a specialist in translating financial documents from Japanese to English using relevant translation pairs. Except when adhering to the translations provided in the relevant translation pairs, you consistently use the most standard financial terms and expressions related to finance.”

The translation prompt 60 may further include a unit conversion instruction. The unit conversion instruction includes an instruction for the language model 14 to convert, when the source text includes one or more numerical values expressed in a unit specific to a region where the first language is used, the numerical values into a unit used in a region where the second language is used. This instruction may, for example, allow units based on the traditional Japanese measurement system to be converted into units based on the imperial system.

The translation prompt 60 may further include a currency conversion instruction. The currency conversion instruction may include an instruction for the language model 14 to convert, when one or more source texts include a monetary amount expressed in a currency unit in the region where the first language is used, the monetary amount into a currency unit used in the region where the second language is used. The instruction may permit, for example, the conversion of Japanese yen to US dollars. The currency conversion instruction may include an instruction for the language model 14 to convert the monetary amount based on the exchange rate at the time of the translation.

The functional unit 208 is a translation prompt input unit 208. The translation prompt input unit 208 is configured to input the translation prompt 60 generated by the translation prompt generator 207 into the language model 14. The functional unit 209 is a response acquisition unit 209. The response acquisition unit 209 is configured to acquire, as a response, one or more completions 61 that have been output by the language model 14 based on the translation prompt 60. The one or more completions 61 include, for example, the translated text of one or more source texts included in the translation prompt 60.

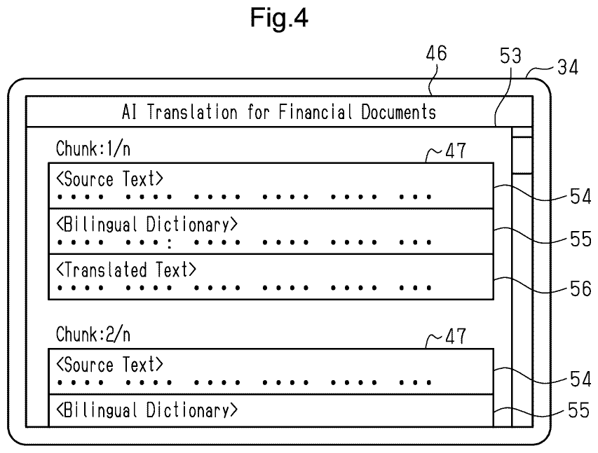

The functional unit 210 is a response generator 210. The response generator 210, for instance, when acquiring multiple completions 61 from the language model 14, adds the pre-translation terms and post-translation terms included in a translation prompt 60 that has been input for acquiring those completions 61. The response generator 210 is configured to generate a response text 53 by, for example, joining multiple completions 61 to each other. The response generator 210 may, for example, supplement or edit the response text 53. The functional unit 210 is a response output unit 211. The response output unit 211 is configured to output a response text 53 that has been generated by the response generator 210 to the response window 46 (refer to FIG. 4).

### Terminal Device

As shown in FIGS. 1, 3, and 4, when the processor 31 runs the program 35 to execute processes, the terminal device 30 operates as a device that includes functional units 301 to 304. The functional units 301 to 304 may be program code.

The functional unit 301 is a bilingual dictionary input unit 301. The bilingual dictionary input unit 301 is configured to input one or more bilingual dictionaries 36 stored in the memory 32 of the terminal device 30 into the information processing device 20. The bilingual dictionary input unit 301 is configured to specify one or more bilingual dictionaries 36 for input into the information processing device 20, based on user input via the terminal device 30. The input into the terminal device 30 may be, for example, dragging and dropping an icon representing the bilingual dictionary 36 onto an operation area 44, which is included in a settings window 41.

The functional unit 302 is an electronic document input unit 302. The electronic document input unit 302 is configured to input one or more electronic documents 37 stored in the memory 32 of the terminal device 30 into the information processing device 20. The electronic document input unit 302 is configured to specify one or more electronic documents 37 for input into the information processing device 20, based on user input via the terminal device 30. The input into the terminal device 30 may be, for example, dragging and dropping an icon representing the electronic document 37 onto an operation area 45, which is included in a settings window 41.

The functional unit 303 is a translation condition input unit 303. The translation condition input unit 303 is configured to input a translation condition into the information processing device 20. The translation condition input unit 303 is configured to specify a translation condition for input into the information processing device 20, based on user input via the terminal device 30. The input into this terminal device 30 may be, for example, entering text data indicating the designated fiscal year into an operation area 43, which is included in the settings window 41.

The functional unit 304 is a response display unit 304. The response display unit 304 is configured to display, in the response window 46 (refer to FIG. 4), a response text 53 that has been output from the response output unit 211.

### Settings Window

As shown in FIG. 1, the monitor 34 may display the settings window 41. The settings window 41 may include operation areas 42 to 45. The operation area 42 is operated to, for instance, download the bilingual dictionary 26 from the information processing device 20. The operation area 43 is operated to, for example, input a translation condition. The operation area 43 is operated to, for example, input the designated fiscal year as text data. The operation area 44 is operated to, for example, input a new bilingual dictionary 36 into the information processing device 20. The operation area 45 is operated, for example, to input an electronic document 37.

### Response Window

As shown in FIG. 4, the monitor 34 may display the response window 46. The response window 46 displays the response text 53. The response window 46 includes one or more display areas 47. Each of the one or more display areas 47 is displayed in correspondence with one chunk 52. Each of the one or more display areas 47 includes a display area 54 that displays a source text, a display area 55 that displays a pre-translation term and a post-translation term, and a display area 56 that displays a translated text. The display area 55 displays the relevant translation pair used to translate each chunk 52.

### Information Processing Method

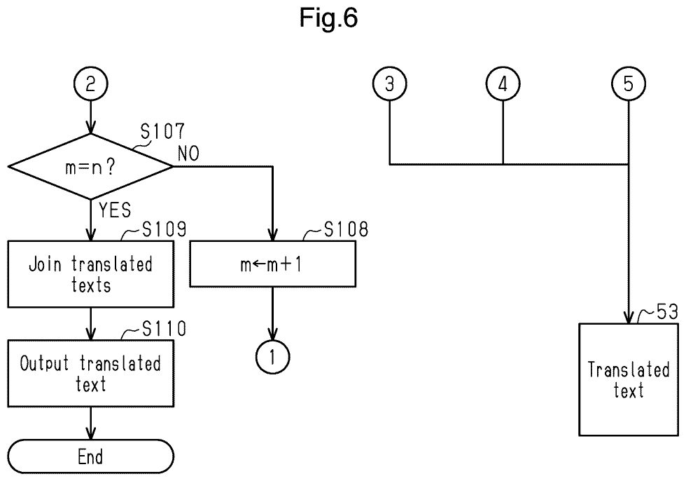

The information processing method for translating a financial document, originally written in the first language as the source text, into the second language by the information processing system 11 will now be described with reference to FIGS. 5 and 6.

As a prerequisite, when an icon representing a bilingual dictionary 36 is dragged and dropped onto the operation area 44, the processor 21, operating as the bilingual dictionary acquisition unit 201, acquires one or more bilingual dictionaries 36 from the memory 32 of the terminal device 30. The processor 21, operating as the bilingual dictionary acquisition unit 201, may store the bilingual dictionary 36 in the memory 22 as the bilingual dictionary 26. As a prerequisite, when the operation area 43 receives text data indicating a designated fiscal year, the processor 21, operating as the translation condition acquisition unit 206, acquires the designated fiscal year as one of the translation conditions.

As shown in FIG. 5, when the icon indicating the electronic document 37 is dragged and dropped onto the operation area 43, the processor 21, operating as the electronic document acquisition unit 202, acquires one or more electronic documents 37 from the memory 32 of the terminal device 30 in step S100. Since the one or more electronic documents 37 each include one or more source texts, the one or more source texts are acquired in step S100. The one or more source texts are, for example, written in the first language. Each source text may include at least one of a text relevant to finance or a financial term. The processor 21, operating as the electronic document acquisition unit 202, may store the electronic document 37 in the memory 22 as the electronic document 27.

In step S101, the processor 21, operating as the splitter 203, splits one or more source texts included in the electronic document 27 into n chunks 52. The splitter 203 may extract only text data from the electronic document 27 and then split the text data. In this case, each chunk 52 includes only text data and does not include tables or figures.

The splitter 203 may split multiple source texts into multiple chunks 52 at proper breaks such as sentence endings, line breaks, paragraphs, and page breaks. The data size (e.g., the number of tokens) of each chunk 52 is set to be lower than the amount of data that can be input into the language model 14 at one time.

In step S102, the processor 21, operating as the term search unit 204, searches the m-th chunk 52 using multiple search terms included in the bilingual dictionary 26. In step S102 of the first time, m is 1. In step S102 of the second or subsequent times, m is a value subsequent to being updated in step S108.

In step S103, the processor 21, operating as the term extraction unit 205, extracts relevant translation pairs from the bilingual dictionary 26. If there is no description that matches a search term in the source text to be translated, the relevant translation pair will not be extracted.

In step S104, the processor 21, operating as the translation prompt generator 207, generates a translation prompt 60 to be input into the language model 14. The translation prompt 60 includes one or more source texts contained in the m-th chunk 52. The translation prompt 60 includes the relevant translation pair extracted by the processor 21, operating as the term extraction unit 205. The translation prompt 60 includes a translation instruction. The translation prompt 60 may include a unit conversion instruction. The translation prompt 60 may include a currency conversion instruction.

In step S105, the processor 21, operating as the translation prompt input unit 208, inputs the translation prompt 60 into the language model 14. In step S106, the processor 21, operating as the response acquisition unit 209, acquires one or more completions 61 that have been output by the language model 14 as a response. Each of the one or more completions 61 includes, for example, the translated text of one or more source texts contained in the corresponding one of one or more chunks 52.

As shown in FIG. 6, in step S107, the processor 21, operating as a different functional unit, determines whether the current chunk 52 is the n-th chunk 52. When the current chunk 52 is not the n-th chunk 52, the processor 21, operating as the different functional unit, updates m to m+1 in step S108. Subsequently, the processor 21 returns to step S102 (refer to FIG. 5).

When the current chunk 52 is the n-th chunk 52, the processor 21, operating as the response generator 210, joins multiple completions 61 to generate a response text 53 in step S109. In step S110, the processor 21, operating as the response output unit 211, outputs a final response text 53 to the response window 46.

### Operation of Present Disclosure

The language model 14 does not fully understand the overall meaning of a source text to produce a consistent translation. Thus, the language model 14 may assign multiple different translated terms to the same word in a source text. Such inconsistency in translated terms, without meaningful justification, is not appropriate for a translation.

To solve this problem, it may be possible to input all relevant translation pairs for a financial document, along with an instruction text, as a prompt to the language model 14 to output a response based on the translation instruction. However, in general, there is a limit to the token length that can be input as a prompt into the language model 14. Thus, including all translation pairs in the prompt reduces the amount of data that can be allocated to the source text. As a result, the number of chunks increases, leading to longer processing times and higher computational load on the language model 14.

To solve this problem, the information processing system 11 of the present disclosure includes a relevant translation pair and a translation instruction, in addition to the source text obtained from the electronic document 37, in the translation prompt 60. The translation instruction includes an instruction that uses a relevant translation pair to cause the language model 14 to translate the source text written in the first language into the second language. Thus, more accurate translated texts are obtained by unifying the translated terms using the relevant translation pair.

Due to limitations on the token length that can be input as a prompt, including all of the translation pairs from the bilingual dictionary 26 proves is impractical. To solve this problem, a translation prompt 60 includes a relevant translation pair that is to be always used for translating the source text. The relevant translation pair includes one or more pre-translation terms that are included in the source text to be translated, and one or more post-translation terms that respectively correspond to the one or more pre-translation terms. This allows the translation prompt 60 to include only the relevant translation pair that the language model 14 uses for translation. Thus, the amount of information that is input into language model 14 is reduced. Accordingly, more information of different types are added to the translation prompt 60.

A pre-translation term is extracted by using a search term corresponding to the pre-translation term to search the source text, rather than using the pre-translation term. When a pre-translation term includes variables such as dates or fiscal years, it may be possible to search the source text using a large number of search terms that are set to cover those variables comprehensively. However, such a method would require a search term for every possible combination of numerical values the variables can take. In such a case, there is a possibility that some search terms are omitted due to user oversight. To solve this problem, in the information processing system 11 of the present disclosure, a search term includes one or more regular expressions. This enables a comprehensive search of the source text using search terms.

The bilingual dictionary 26 does not necessarily include all terms contained in one or more source texts. To solve this problem, the translation instruction in a translation prompt 60 includes an instruction for the language model 14 to translate one or more terms, other than the one or more pre-translation terms included in one or more source texts, using financial terms. This allows even the terms that are not listed in the bilingual dictionary 26 to be translated accurately.

One or more source texts may include a fiscal year. It may be inappropriate to include one or more fiscal years contained in the source text in a translated text. To solve this problem, in the information processing system 11 of the present disclosure, the translation prompt 60 includes a translation instruction that instructs the language model 14 to generate a translated text by replacing the number of the fiscal year included in one or more source texts with the current fiscal year or the designated fiscal year. This allows the fiscal year included in a translated text to be described accurately.

One or more source texts may include numerical values represented in the unit specific to the region where the first language is used. When a translated text written in the second language includes numerical values expressed in the unit specific to the region where the first language is used, the user reading the translated text may have difficulty visualizing the magnitude of the numerical values. To solve this problem, in the information processing system 11 of the present disclosure, the translation prompt 60 includes a unit conversion instruction to enable the language model 14 to convert one or more numerical values into the unit used in the region where the second language is used. Thus, in the translated text, one or more numerical values expressed in the unit specific to the region where the first language is used are converted to those expressed in the unit used in the region where the second language is used.

One or more source texts may include a monetary amount expressed in the currency unit of the region where the first language is used. When a translated text written in the second language includes a monetary amount expressed in the currency unit of the region where the first language is used, the user reading the translated text may have difficulty understanding the magnitude of the monetary amount. To solve this problem, in the information processing system 11 of the present disclosure, the translation prompt 60 includes a currency conversion instruction to enable the language model 14 to convert a monetary amount into the currency unit of the region where the second language is used. Thus, in the translated text, the monetary amount expressed in the currency unit of the region where the first language is used is converted to the monetary amount expressed in the currency unit of the region where the second language is used. Additionally, using the current exchange rate for currency unit allows for more accurate conversion of monetary amount.

### Advantages of Present Disclosure

The present disclosure has the following advantages.
(1) The translation prompt 60 includes relevant translation pairs that have been extracted from the bilingual dictionary 26. Thus, compared to including all the translation pairs from the bilingual dictionary 26 in the translation prompt 60, the amount of information to be input into the language model 14 is reduced. Accordingly, the processing time and the computational load on the language model 14 are reduced.
(2) To search one or more source texts, search terms that respectively correspond to pre-translation terms, rather than the pre-translation terms, are used. The translation prompt 60 includes one or more pre-translation terms that correspond to one or more search terms matched during the search. Thus, the search is optimized to increase the likelihood of matching terms that are difficult to find with the pre-translation terms.
(3) Search terms each include one or more regular expressions. This allows pre-translation terms that respectively conform to regular expressions to be extracted comprehensively.
(4) The translation instruction includes an instruction for the language model 14 to generate a translated text by replacing the number of the fiscal year included in one or more source texts with the current fiscal year or the designated fiscal year. This allows for generation of a translated text in which the fiscal year included in one or more source texts is correctly replaced.
(5) The translation instruction includes an instruction for the language model 14 to translate one or more terms, other than one or more pre-translation terms included in one or more source texts, using financial terms. This allows even the terms that are not listed in the bilingual dictionary 26 to be translated into standard financial terms.
(6) The translation prompt 60 includes a unit conversion instruction for the language model 14 to convert, when the source text includes one or more numerical values expressed in a unit specific to the region where the first language is used, the numerical values into the unit used in the region where the second language is used. Thus, the translated text presents numerical values converted into the unit of the region where the second language is used. This allows the information processing system 11 to output more accurate translated texts.
(7) The translation prompt 60 includes a currency conversion instruction for the language model 14 to convert, when one or more source texts include a monetary amount expressed in the currency unit in the region where the first language is used, the monetary amount into the currency unit used in the region where the second language is used. Thus, the translated text presents monetary amounts converted into the currency unit of the region where the second language is used. This allows the information processing system 11 to output translated texts that are suitable for the region.
(8) The currency conversion instruction may include an instruction for the language model 14 to convert the monetary amount based on the current exchange rate. This allows the translated text to reflect the monetary amount based on the current exchange rate.

### Modifications

The present embodiment may be modified as follows. The present embodiment and the following modifications can be combined as long as they remain technically consistent with each other.

### First Modification

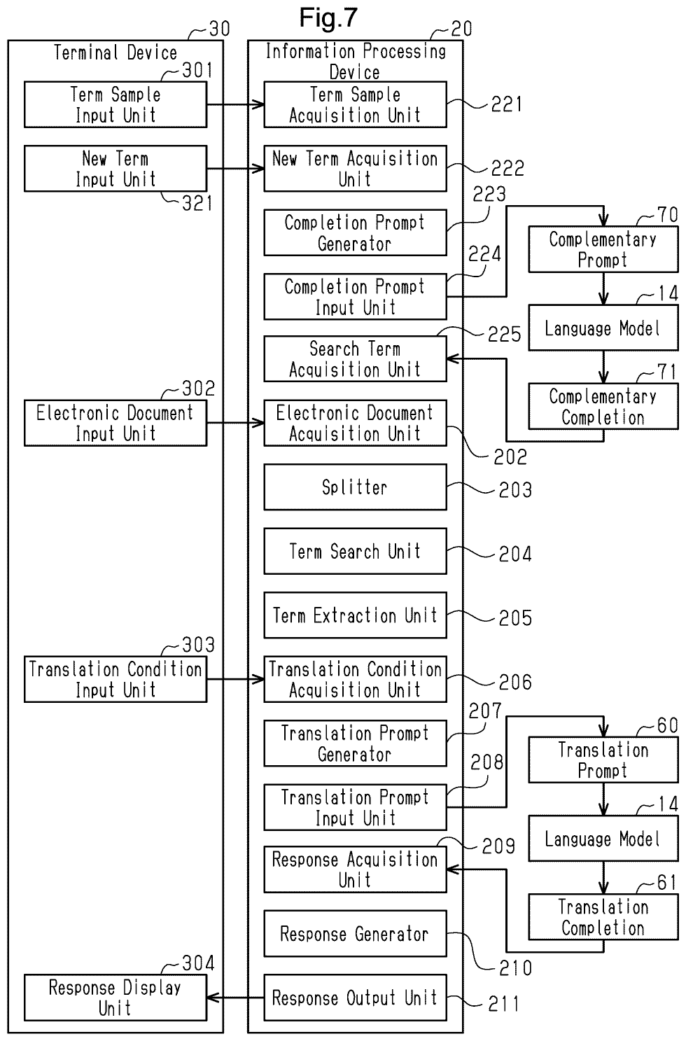

As shown in FIG. 7, the information processing system 11 may be configured to acquire one or more new search terms from the language model 14. The functional units 202 to 211 and 301 to 304 that are the same as the corresponding components of the present embodiment will not be described in detail.

The information processing device 20 includes not only the functional units 202 to 211 but also functional units 221 to 224. The information processing device 20 may include the functional unit 201. The functional unit 221 is a term sample acquisition unit 221. The term sample acquisition unit 221 is configured to acquire, as term samples, at least some of the pre-translation terms contained in the bilingual dictionary 26 or 36 and one or more search terms respectively corresponding to these pre-translation terms.

The term sample acquired by the term acquisition unit 221 is used as ground truth data that indicates the relationship between a search term and a pre-translation term. The term acquisition unit 221 may be configured to, for example, acquire one or more pre-translation terms designated in response to user input via the terminal device 30, and acquire one or more search terms respectively corresponding to the pre-translation terms.

The functional unit 222 is a new term acquisition unit 222. The new term acquisition unit 222 is configured to, for example, acquire one or more new terms. New terms are expressed in the first language and are not listed in the bilingual dictionary 26. The new term acquisition unit 222 may be configured to, for example, acquire one or more designated new terms based on user input via the terminal device 30.

The functional unit 223 is a completion prompt generator 223. The completion prompt generator 223 is configured to, for example, generate a completion prompt 70. The completion prompt 70 includes, for example, a term sample extracted from the bilingual dictionary 26, one or more new terms, and a completion instruction. The completion instructions include an instruction for the language model 14 to output one or more new search terms respectively corresponding to one or more new terms based on the relationship of search terms with pre-translation terms in the term sample.

The functional unit 224 is a completion prompt input unit 224. The completion prompt input unit 224 is configured to input a completion prompt 70 that has been generated by the completion prompt generator 223 into the language model 14.

The functional unit 225 is a search term acquisition unit 225. The search term acquisition unit 225 is configured to acquire one or more new search terms from the language model 14. The search term acquisition unit 225 is configured to, for example, acquire one or more supplementary completions 71 that have been output by the language model 14 as a response, based on the completion prompt 70. The supplementary completions 71 include one or more search terms respectively corresponding to one or more new terms.

The search term acquisition unit 225 may map one or more new terms to one or more search terms acquired from the language model 14 and add them to the bilingual dictionary 26. The search term acquisition unit 225 may map one or more post-translation terms to one or more new terms and add the one or more post-translation terms to the bilingual dictionary 26. The one or more post-translation terms mapped to one or more new terms may be designated according to user input via the terminal device 30. One or more post-translation terms mapped to one or more new terms may be generated by the language model 14 together with one or more search terms. The term search unit 204 may search a source text using the search terms acquired by the search term acquisition unit 225.

The terminal device 30 includes a functional unit 321 in addition to the functional units 301 to 304. The functional unit 321 is a new term input unit 321. The new term input unit 321 is configured to input one or more new terms into the information processing device 20. The new term input unit 321 is configured to specify one or more new terms to be input into the information processing device 20, based on user input via the terminal device 30. The input may involve, for example, the user entering text data indicating one or more new terms into a specific area included in the settings window 41. Alternatively, the input may involve the user dragging and dropping an icon that indicates an electronic document containing one or more new terms onto a specific area included in the settings window 41.

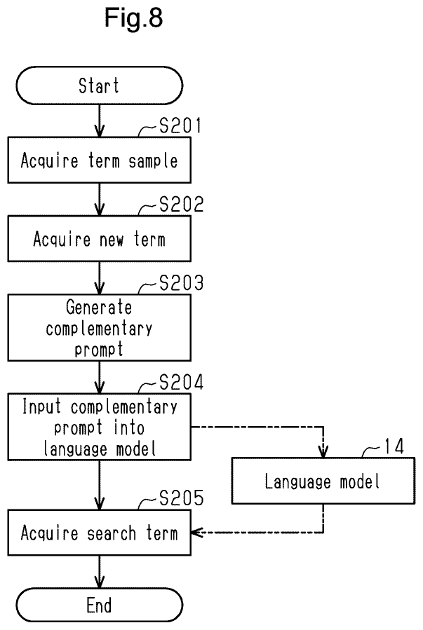

The information processing method for acquiring one or more search terms respectively corresponding to one or more new terms will now be described with reference to FIG. 8. In step S201, the processor 21, operating as the term acquisition unit 221, acquires a term sample from the bilingual dictionary 26 or 36. The term sample includes one or more pre-translation terms and one or more search terms corresponding to the one or more pre-translation terms.

When one or more new terms are input in response to user input via the terminal device 30, the processor 21, operating as the new term acquisition unit 222, acquires the one or more new terms in step S202. In step S203, the processor 21, operating as the completion prompt generator 223, generates a completion prompt 70. The completion prompt 70 includes the one or more new terms, which have been acquired by the new term acquisition unit 222, and the term samples acquired by the term sample acquisition unit 221.

In step S204, the processor 21, operating as the completion prompt input unit 224, inputs the completion prompt 70 generated in step S203 into the language model 14. In step S205, the processor 21, operating as the search term acquisition unit 225, acquires one or more supplementary completions 71 that have been output by the language model 14 based on the completion prompt 70.

One or more search terms may include regular expressions. Regular expressions are useful for ensuring that pre-translation terms corresponding to search terms are comprehensively matched. However, for users who are not familiar with regular expressions, expressing search terms in regular expression format can be challenging. To solve this problem, the information processing system 11 of this modification generates a completion prompt 70 and acquires, based on the completion prompt 70, one or more search terms that have been output by the language model 14. This allows even users who are not familiar with regular expressions to readily acquire search terms written in regular expression format.

### Second Modification

The unit conversion instruction may include an instruction for the language model 14 to convert, when one or more source texts include one or more numerical values expressed in the unit specific to the region where the first language is used, each of the numerical values into a corresponding unit included in the International System of Units. This modification provides a correct translated text regardless of the type of second language or the region where the second language is used.

### Third Modification

The functional units 201 to 211 and 221 to 225 may be implemented by one information processing device 20 or by three or more information processing devices 20. The functional units 201 to 211 and 221 to 225 may be implemented by one terminal device 30 or by three or more terminal devices 30. Further, steps S100 to S110 and S201 to S205 may each be executed by a different functional unit (program code). The functional units 301 to 304 and 321 may be implemented by one terminal device 30 or by three or more terminal devices 30. The functional units 301 to 304 and 321 may be implemented by one information processing device 20 or by three or more information processing devices 20. Thus, the information processing system 11 does not have to include one or more information processing devices 20 or one or more terminal devices 30. The information processing system 11 does not have to include the terminal device 30. The information processing system 11 does not have to include the information processing device 20.

### Fourth Modification

The electronic documents 27 and 37 are not limited to financial documents. The electronic documents 27 and 37 may be academic papers, reports, educational texts, conference materials, sales materials, patent literature, or instruction manuals in a specific technical field.

### Fifth Modification

The language model to input a completion prompt 70 and acquire a supplementary completion 71 and the language model to input a translation prompt 60 and acquire a translation completion 61 may be the same language model or different language models.

### Sixth Modification

The information processing system 11 may include one or more information processing devices 20 that implement various features of the present disclosure using an external language model 14. The information processing system 11 may be a translation system. The information processing method of the present disclosure may be a translation method. The program in the present disclosure may be a translation program.

Technical concepts that can be understood from each of the above embodiment and modified examples will now be described

### [Clause 1]

An information processing system configured to translate one or more source texts written in a first language into a second language using a language model, the information processing system including:
one or more memories configured to store a program; and
one or more processors configured to execute processes based on the program, where
the one or more processors are configured to execute:
   extracting, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms;
   inputting a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
   acquiring, from the language model, a translated text in which the one or more source texts are translated into the second language according to the translation instruction.

### [Clause 2]

The information processing system according to clause 1, where
the bilingual dictionary includes search terms respectively corresponding to the pre-translation terms, and
the one or more processors are further configured to execute:
   searching the one or more source texts using the search terms; and
   acquiring the one or more pre-translation terms respectively corresponding to one or more of the search terms matched in the search.

### [Clause 3]

The information processing system according to clause 2, where
the search terms each include one or more regular expressions.

### [Clause 4]

The information processing system according to clause 3, where
the one or more regular expressions include a regular expression that represents a fiscal year,
the one or more processors are further configured to execute acquiring a current fiscal year or a designated fiscal year that has been input by a user, and
the translation instruction includes an instruction for the language model to generate the translated text by replacing a number of a fiscal year included in the one or more source texts with the current fiscal year or the designated fiscal year.

### [Clause 5]

The information processing system according to any one of clauses 2 to 4, where
the language model is a general-purpose language model capable of executing multiple language processing tasks that include translation and text completion, and
the one or more processors are configured to execute:
   acquiring one or more new terms, the one or more new terms being not included in the bilingual dictionary written in the first language;
   inputting a completion prompt to the language model, the completion prompt including at least some pre-translation terms included in the bilingual dictionary, one or more search terms respectively corresponding to the at least some pre-translation terms, the one or more new terms, or a completion instruction, the completion instruction including an instruction for the language model to output one or more new search terms respectively corresponding to the one or more new terms based on a relationship of the one or more search terms with the at least some pre-translation terms; and
   search term acquisition code configured to acquire the one or more new search terms from the language model.

### [Clause 6]

The information processing system according to any one of clauses 1 to 4, where
the one or more source texts include one or more texts relevant to finance,
the pre-translation terms include one or more financial terms, and
the translation instruction includes an instruction for the language model to translate one or more terms, other than the one or more pre-translation terms included in the one or more source texts, using the financial terms.

### [Clause 7]

The information processing system according to any one of clauses 1 to 4, where
the translation prompt further includes a unit conversion instruction, and
the unit conversion instruction includes an instruction for the language model to convert, when the one or more source texts include one or more numerical values expressed in a unit specific to a region where the first language is used, the one or more numerical values into a unit used in a region where the second language is used.

### [Clause 8]

The information processing system according to any one of clauses 1 to 4, where
the translation prompt further includes a unit conversion instruction, and
the unit conversion instruction includes an instruction for the language model to convert, when the one or more source texts include one or more numerical values expressed in a unit specific to a region where the first language is used, each of the one or more numerical values into a corresponding unit included in the International System of Units.

### [Clause 9]

The information processing system according to any one of clauses 1 to 4, where
the translation prompt further includes a currency conversion instruction, and
the currency conversion instruction includes an instruction for the language model to convert, when the one or more source texts include a monetary amount expressed in a currency unit in a region where the first language is used, the monetary amount into a currency unit of a region where the second language is used.

### [Clause 10]

The information processing system according to clause 9, where
the one or more processors are configured to further acquire a current exchange rate, and
the currency conversion instruction includes an instruction for the language model to convert the monetary amount based on the exchange rate.

### [Clause 11]

11. An information processing method configured to translate one or more source texts written in a first language into a second language using a language model, the information processing method including causing one or more processors to execute:
extracting, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms;
inputting a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
acquiring, from the language model, a translated text in which the one or more source texts are translated into the second language according to the translation instruction.

### [Clause 12]

A program for translating one or more source texts written in a first language into a second language using a language model, the program including:
program code for extracting, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms; and
program code for inputting a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
program code for acquiring, from the language model, a translated text in which the one or more source texts are translated into the second language according to the translation instruction.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing system configured to translate one or more source texts written in a first language into a second language using a language model, the information processing system comprising:
one or more memories that store computer program code; and
one or more processors, wherein
the one or more processors are configured to read the program code and operate as instructed by the program code, and
the program code includes:
extraction code configured to extract, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms;
translation prompt input code configured to input a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
translated text acquisition code configured to acquire, from the language model, a translated text in which the one or more source texts are translated into the second language according to the translation instruction.

2. The information processing system according to claim 1, wherein
the bilingual dictionary includes search terms respectively corresponding to the pre-translation terms, and
the program code further includes:
search code configured to search the one or more source texts using the search terms; and
pre-translation term acquisition code configured to acquire the one or more pre-translation terms respectively corresponding to one or more of the search terms matched in the search.

3. The information processing system according to claim 2, wherein
the search terms each include one or more regular expressions.

4. The information processing system according to claim 3, wherein
the one or more regular expressions include a regular expression that represents a fiscal year,
the program code further includes fiscal year designation code configured to acquire a current fiscal year or a designated fiscal year that has been input by a user, and
the translation instruction includes an instruction for the language model to generate the translated text by replacing a number of a fiscal year included in the one or more source texts with the current fiscal year or the designated fiscal year.

5. The information processing system according to claim 2, wherein
the language model is a general-purpose language model capable of executing multiple language processing tasks that include translation and text completion, and
the program code includes:
new term acquisition code configured to acquire one or more new terms, the one or more new terms being not included in the bilingual dictionary written in the first language;
completion prompt input code configured to input a completion prompt to the language model, the completion prompt including at least some pre-translation terms included in the bilingual dictionary, one or more search terms respectively corresponding to the at least some pre-translation terms, the one or more new terms, or a completion instruction, the completion instruction including an instruction for the language model to output one or more new search terms respectively corresponding to the one or more new terms based on a relationship of the one or more search terms with the at least some pre-translation terms; and
search term acquisition code configured to acquire the one or more new search terms from the language model.

6. The information processing system according to claim 1, wherein
the one or more source texts include one or more texts relevant to finance,
the pre-translation terms include one or more financial terms, and
the translation instruction includes an instruction for the language model to translate one or more terms, other than the one or more pre-translation terms included in the one or more source texts, using the financial terms.

7. The information processing system according to claim 1, wherein
the translation prompt further includes a unit conversion instruction, and
the unit conversion instruction includes an instruction for the language model to convert, when the one or more source texts include one or more numerical values expressed in a unit specific to a region where the first language is used, the one or more numerical values into a unit used in a region where the second language is used.

8. The information processing system according to claim 1, wherein
the translation prompt further includes a unit conversion instruction, and
the unit conversion instruction includes an instruction for the language model to convert, when the one or more source texts include one or more numerical values expressed in a unit specific to a region where the first language is used, each of the one or more numerical values into a corresponding unit included in the International System of Units.

9. The information processing system according to claim 1, wherein
the translation prompt further includes a currency conversion instruction, and
the currency conversion instruction includes an instruction for the language model to convert, when the one or more source texts include a monetary amount expressed in a currency unit in a region where the first language is used, the monetary amount into a currency unit of a region where the second language is used.

10. The information processing system according to claim 9, wherein
the one or more processors are configured to further acquire a current exchange rate, and
the currency conversion instruction includes an instruction for the language model to convert the monetary amount based on the exchange rate.

11. An information processing method configured to translate one or more source texts written in a first language into a second language using a language model, the information processing method comprising causing one or more processors to execute:
extracting, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms;
inputting a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
acquiring, from the language model, a translated text in which the one or more source texts are translated into the second language according to the translation instruction.

12. A non-transitory computer-readable medium storing program code for translating one or more source texts written in a first language into a second language using a language model, the program code comprising:
extraction code configured to extract, from a bilingual dictionary that includes pre-translation terms described in the first language and post-translation terms described in the second language respectively corresponding to the pre-translation terms, one or more pre-translation terms relevant to the one or more source texts and one or more post-translation terms respectively corresponding to the one or more pre-translation terms;
translation prompt input code configured to input a translation prompt into the language model, the translation prompt including the one or more source texts, the one or more pre-translation terms, the one or more post-translation terms, and a translation instruction, and the translation instruction including an instruction for the language model to translate the one or more pre-translation terms to the one or more post-translation terms; and
translated text acquisition code configured to acquire, from the language model, a translated text in which the one or more source texts are translated into the second language according to the translation instruction.
